(19) United States
(12) Patent Application Publication
(10) Pub. No.: US 2012/0096747 A1
(43) Pub. Date: Apr. 26, 2012

(54) LICENSE PLATE FRAME STRUCTURE

(75) Inventor: LI-HUA LEE YANG, TAINAN CITY (TW)

(73) Assignee: SUPER LEE ENTERPRISE CO., LTD., TAINAN CITY (TW)

(21) Appl. No.: 12/910,067

(22) Filed: Oct. 22, 2010

(51) Int. Cl. B60R 11/00

(52) U.S. Cl. 40/209

(57) ABSTRACT

A license plate frame structure, essentially comprising at least a soft flexible frame body the front and the rear sides of which are respectively extended inwardly to form a first frame side portion and a second frame side portion so as to clamp a license plate therebetween. The screw fasteners provided on the license plate is hided at the rear side of the first frame side portion so that exposure of sharp edge of the license plate can be avoided so as to prevent slash accident. The width of the first frame side portion is made to be smaller than that of the second frame side portion which is closely clamped between the license plate and the vehicle, so that stability is improved to avoid falling. Further, a mild light-reflective portion is provided on the soft flexible frame body to achieve apparent alert function.

### BACKGROUND OF THE INVENTION

1. Field of the Invention

This invention relates to a license plate frame structure, more particularly to a license plate frame structure in which a license plate is clamped and screw fasteners provided on the license plate are hided so as to provide effective protection.

2. Brief Description of the Prior Art

A conventional license plate frame is disclosed in Taiwanese Patent Gazette No. M372800 entitled “License Plate Device”, which is adapted to be mounted on car body for fixing the license plate. The license plate frame comprises: a frame having a loop-shape frame body and a plurality of spaced convex body for positioning securely fixed on the frame body which has an upper frame side portion and a lower frame side portion spaced in upper-lower direction, the plural convex bodies for positioning being distributed in upper-lower and left-right spaced manner and extended oppositely from the upper frame side portion and the lower frame side portion so that a license plate can be disposed and limited between the plural convex bodies and the opposite sides of the frame body, each of the plural convex bodies having a perforation in front-rear direction; and a plurality of screw penetrating the perforations for fastening the plural positioning convex bodies securely on the car body.

However, in practical implementation of the above license plate frame device, the license plate is mounted and limited between the positioning convex bodies provided on the upper and lower frame side portions, and screws penetrated in the positioning perforations on the positioning convex bodies are fastened on car body to facilitate the mounting of the license plate. Other than these, the above license plate frame device has no additional improved structure and annexed function. Hence, there is still space for improvement. Moreover, the above frame has to be fixed on car body by means of screws, so that it is difficult for ordinary people to fix it.

### SUMMARY OF THE INVENTION

In view of the above disadvantages, this invention proposes a novel license plate frame structure which is for clamping a license plate therein, and the fastening screws provided on the license plate is hided so that exposure of sharp edge of the license plate can be avoided so as to prevent slash accident. The width of the first frame side portion is made to be smaller than that of the second frame side portion which is closely clamped between the license plate and the vehicle, so that stability is improved to avoid falling.

A preferred embodiment of the license plate frame structure of the present invention is characterized in that it essentially comprises at least a soft flexible frame body the front and the rear sides of which is extended inwardly to form a first frame side portion and a second frame side portion so as to clamp a license plate therebetween.

According to a preferred embodiment of the license plate frame structure of the present invention, a mild light-reflective portion is further provided by means of spreading glitter, sequins or fluorescent powder on the soft flexible frame body so as to achieve apparent alert function.

### BRIEF DESCRIPTION OF THE DRAWINGS

FIG. 1 is a perspective exploded view showing the first embodiment of the present invention.

FIG. 2 is a perspective sectional view showing the soft flexible frame body of the present invention.

FIG. 3 is a front assembled view showing the first embodiment of the present invention.

FIG. 4 is a sectional assembled side view showing the first embodiment of the present invention.

FIG. 5 is a front assembled view showing the second embodiment of the present invention.

FIG. 6 is a front assembled view showing the third embodiment of the present invention.

FIG. 7 is a front assembled view showing the fourth embodiment of the present invention.

FIG. 8 is a perspective exploded view showing the fifth embodiment of the present invention.

FIG. 9 is a sectional assembled side view showing the fifth embodiment of the present invention.

### DETAILED DESCRIPTION OF PREFERRED EMBODIMENTS

The objects, the technical contents and the expected effect of the present invention will become more apparent from the detailed description of the preferred embodiment in conjunction with the accompanying drawings.

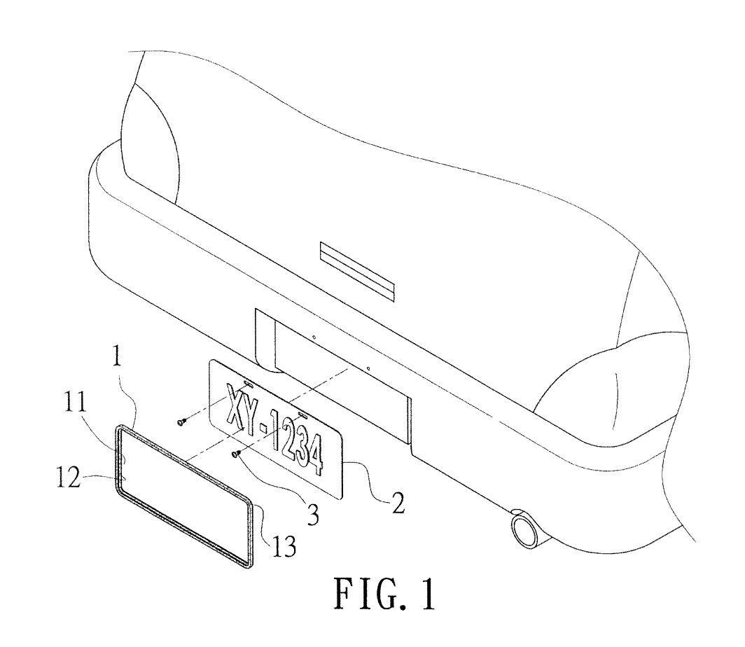

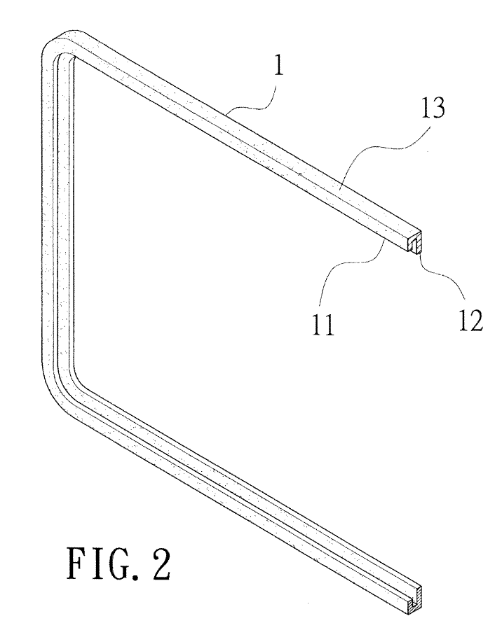

Firstly referring to FIG. 1, which is a schematic view showing a first preferred embodiment of the license plate frame structure of the present invention, the license plate frame structure comprises at least a soft flexible frame body (1) which can be made in various colors from silicon rubber. Referring also to FIG. 2, the front and the rear sides of the soft flexible frame body (1) are respectively extended inwardly to form a first frame side portion (11) and a second frame side portion (12) in such a manner that the width of the first frame side portion (11) is made to be smaller than that of the second frame side portion (12). Thus, a license plate (2) is inserted from between the sides of the first frame side portion (11) and is clamped between the first frame side portion (11) and the second frame side portion (12). Furthermore, a mild light-reflective portion (13) is provided by means of spreading glitter, sequins or fluorescent powder on the soft flexible frame body (1) so as to achieve apparent alert function.

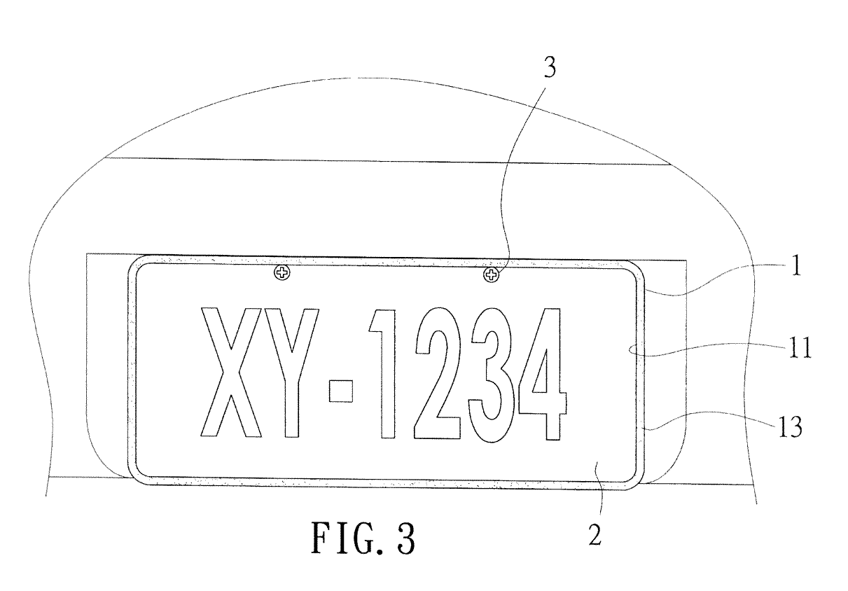

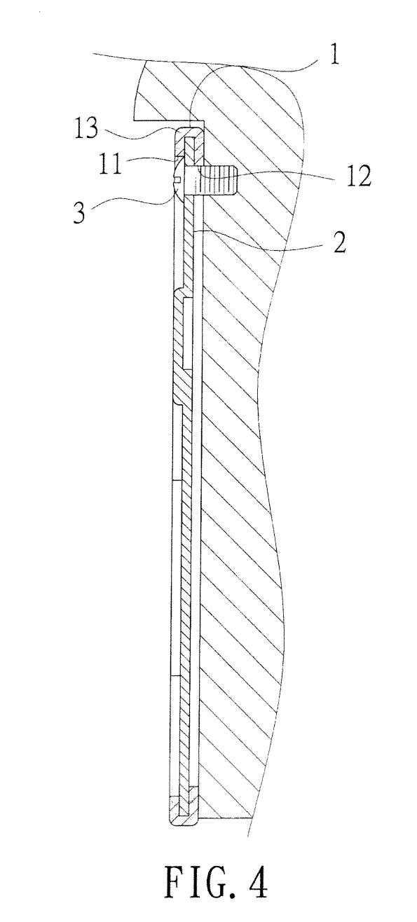

In the implementation of use, as shown in FIGS. 1, 3 and 4, the license plate (2) is firstly inserted from between the sides of the first frame side portion (11), which is at the front side of the soft flexible frame body (1), and is clamped between the first frame side portion (11) and the second frame side portion (12) in such a manner that the license plate (2) and the soft flexible frame body (1) present an entirety in appearance shape, and that the exposure of sharp edge of the license plate (2) can be avoided so as to prevent slash accident. Then, the license plate (2) and the soft flexible frame body (1) are together fastened on the car body by several screw fasteners (3), and the second frame side portion (12) is closely clamped between the license plate (2) and the vehicle so that stability of the soft flexible frame body (1) is improved to avoid falling. The mild light-reflective portion (13) provided on the soft flexible frame body (1) can reflect light during car driving so as to provide warning to the driver behind.

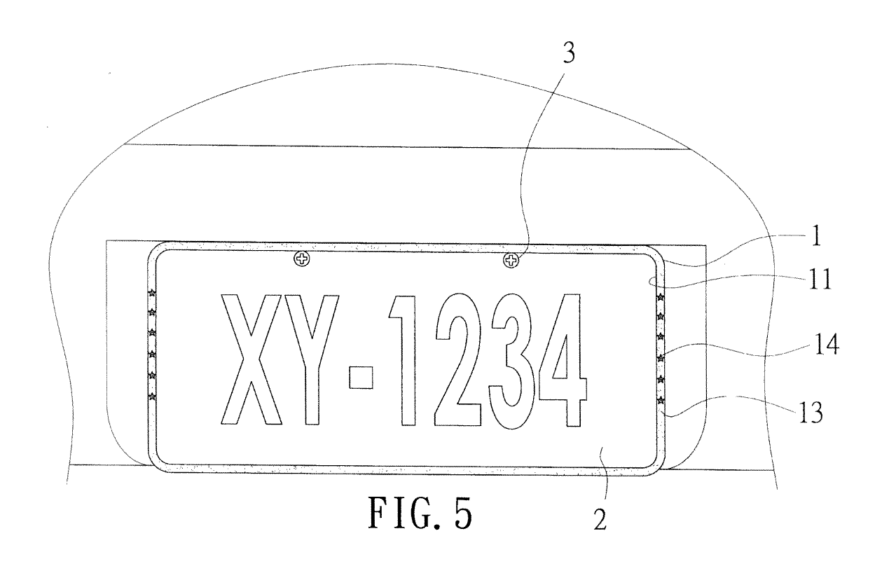

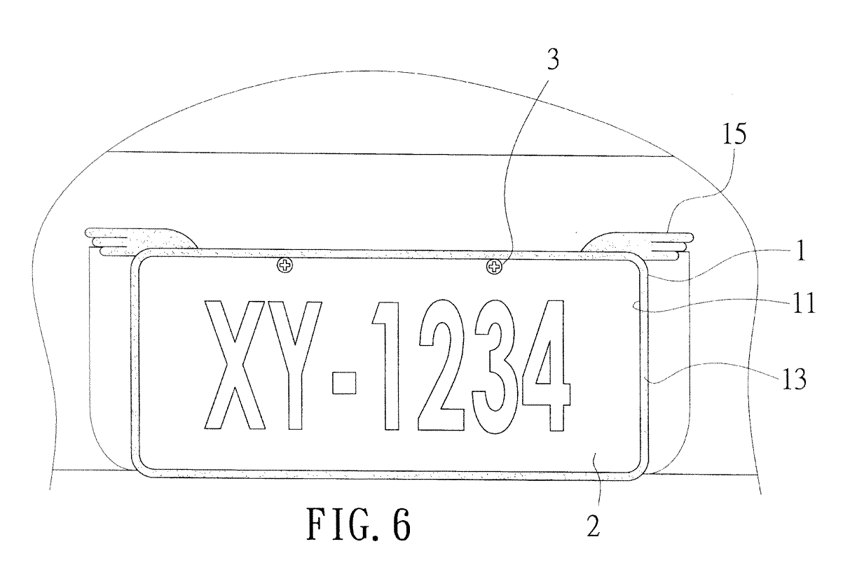

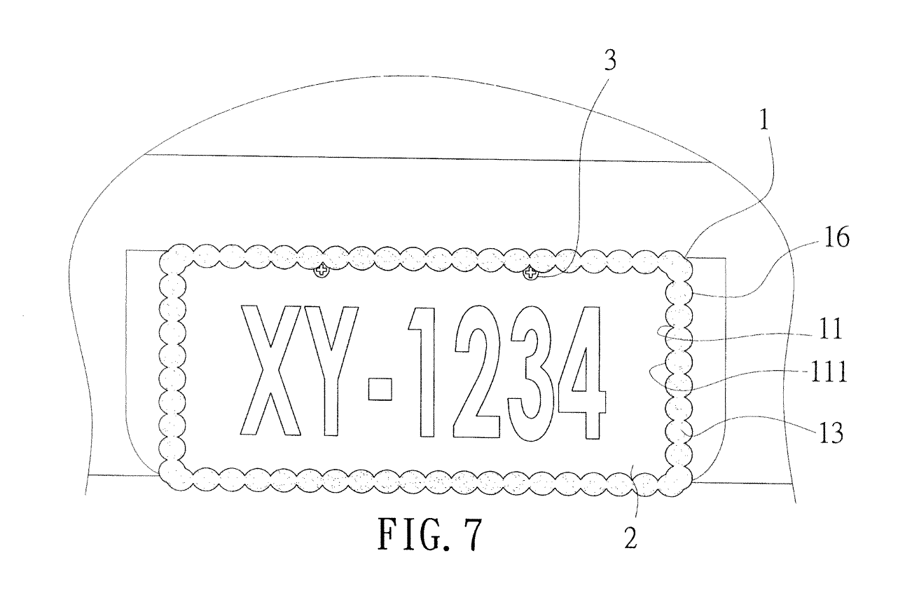

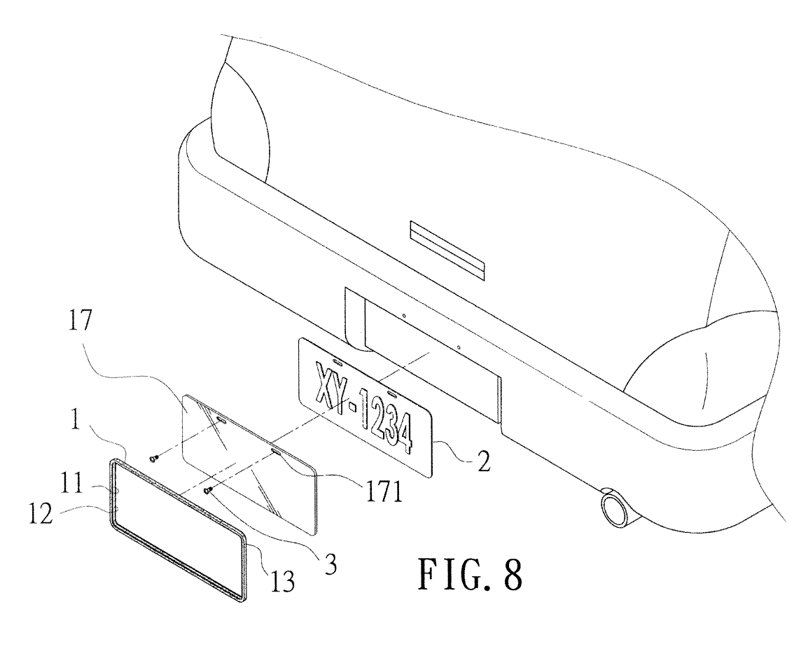

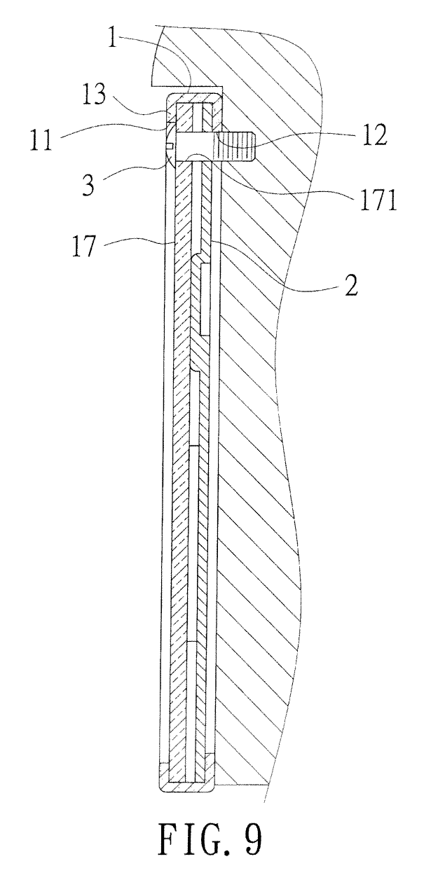

Further referring to FIG. 5, a schematic view showing a second preferred embodiment of the license plate structure of the present invention is shown. The difference of the second preferred embodiment to the first preferred embodiment lies in that a plurality of decoration (14) is further provided on the soft flexible frame body (1). Referring to a schematic view of a third embodiment as shown in FIG. 6, two wing-shape decorations (15) are formed respectively by extending of the top ends of the two sides of the soft flexible frame body (1). In a schematic view of a fourth embodiment as shown in FIG. 7, wave-shape decorations (16), (111) are formed on opposite edges of the soft flexible frame body (1) and the first frame side portion (11). Further, referring to schematic views of a fifth embodiment as shown in FIGS. 8 and 9, a guard plate (17), such as an acrylic plate, is further provided between the first frame side portion (11) and the second frame side portion (12), and a plurality of perforation (171) is provided at suitable positions on the guard plate (17) so that a corresponding number of screw fasteners (3) can pass through the perforations (171) respectively and is fixed on the front side of the license plate (2). Hence, this can avoid the license plate (2) from being damaged by direct collision. However, the above embodiments or drawings are not intended to limit the product aspect, pivot structure or usage mode of the present invention. Many modifications and variations of the present invention are possible in the light of the above teachings. It is therefore to be understood that within the scope of the appended claims, the invention may be practised otherwise than what is specifically described by those skilled in this art.

It is understood from the element constitution and the implementation description that this invention has the following advantages comparing to the prior art.

1. In this invention, a first frame side portion and a second frame side portion are respectively formed on the front and the rear sides of the soft flexible frame body so as to clamp a license plate therebetween. The screw fasteners provided on the license plate is hided at the rear side of the first frame side portion so that exposure of sharp edge of the license plate can be avoided so as to prevent slash accident.

2. In this invention, a first frame side portion and a second frame side portion are respectively formed on the front and the rear sides of the flexible frame body in such a manner that width of the first frame side portion is made to be smaller than that of the second frame side portion so as to increase stability.

3. A mild light-reflective portion is further provided by means of spreading glitter, sequins or fluorescent powder on the soft flexible frame body of the present invention so as to achieve apparent alert function.

4. The soft flexible frame body of the present invention can be made in various colors from silicon rubber. Alternatively, decorations can be formed on the soft flexible frame body to increase selectivity of use.

What is claimed is:

1. A license plate frame structure, comprising at least a soft flexible frame body the front and the rear sides of which are respectively extended inwardly to form a first frame side portion and a second frame side portion so as to clamp a license plate therebetween.

2. The license plate frame structure as claimed in claim 1, wherein said soft flexible frame body is further provided with a mild light-reflective portion.

3. The license plate frame structure as claimed in claim 2, wherein said soft flexible frame body is formed with decorations.

4. The license plate frame structure as claimed in claim 1, wherein a guard plate is further clamped between said first frame side portion and said second frame side portion.

5. The license plate frame structure as claimed in claim 4, wherein a plurality of perforations is formed on said guard plate for the passing-through of screw fasteners.

6. The license plate frame structure as claimed in claim 4, wherein said soft flexible frame body is formed with decorations.

7. The license plate frame structure as claimed in claim 1, wherein said soft flexible frame body is formed with decorations.
